(19) United States
(12) Patent Application Publication
(10) Pub. No.: US 2019/0156390 A1
(43) Pub. Date: May 23, 2019

(54) APPAREL FITTING SYSTEM

(71) Applicant: Henry W. KIM, Los Angeles, CA (US)

(72) Inventor: Henry W. KIM, Los Angeles, CA (US)

(21) Appl. No.: 15/816,999

(22) Filed: Nov. 17, 2017

(51) Int. Cl. G06Q 30/06

(52) U.S. Cl. CPC G06Q 30/0621; G06Q 30/0635

(57) ABSTRACT

A method for apparel fitting system includes steps for providing measurements for garments on the terminal by the user, determining proper sizes for each of the garments by the server using the measurements received from the terminal and tables stored in the server, and suggesting the proper sizes for each of the garments to the user through the terminal by the server. The method may further include a step for ordering the garments on the website by the user. The method may further include a step for updating reference measurements and statics of the reference measurements with the one of more measurements provided by the user. The apparel fitting system may include a server, a terminal accessed by a user, and a website, and the server and the terminal are connected to each other over a network

### BACKGROUND OF THE INVENTION

The present invention relates to an apparel fitting system.

It is challenging to provide a proper size for on-line fitting system, due to the wide range of measurements among different individuals.

Accordingly, a need for an apparel fitting system has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide an apparel fitting system.

A method is provided for apparel fitting in an apparel fitting system including a server, a terminal accessed by a user, and a website, in which the server and the terminal are connected to each other over a network.

The method for apparel fitting system comprises steps for: providing one or more measurements for one or more garments on the terminal by the user; determining proper sizes for each of the one or more garments by the server using the one or more measurements received from the terminal and a plurality of garment tables stored in the server; and suggesting the proper sizes for each of the one or more garments to the user through the terminal by the server.

The step for providing may comprise steps for: visiting the website using the terminal, wherein the website is managed by the server on the network; selecting the one or more garments from a list of sample garments that the website provides along with information on the sample garments; and providing the one or more measurements for the one or more garments on the website by inputting or choosing from values provided by the website.

The list of sample garments may be displayed graphically on the website.

The information on the sample garments may be provided in terms of text, graphics, pictures, video, and audio.

The plurality of garment tables may be provided in a form of database stored in the server and managed by the website.

The plurality of garment tables may comprise reference measurements of the sample garments and statistics of reference measurements.

The one or more measurements may comprise a bust measurement and a hip measurement.

The one or more measurements may further comprise a waist measurement, a thigh measurement, an inseam measurement, a sleeve length measurement, a neck measurement, a bicep measurement, and a combination thereof.

The method may further comprise a step for ordering the one or more garments on the website by the user.

The website may be provided accessibly on the network, and wherein each of the server and the terminal includes one or more memory device configured to store programs, data, and calculation results from each of the steps.

The method may further comprise a step for updating reference measurements and statics of the reference measurements with the one of more measurements provided by the user.

Each of the server and the terminal may comprise at least one information processing unit and at least one display.

The step for suggesting proper sizes may further comprise a step for selecting additional features of the one or more garments including colors.

The advantages of the present invention are: (1) the apparel fitting system according to the invention provides a convenient way for discerning features of different users; and (2) the apparel fitting system according to the invention provides an intelligent way for improving the performance of apparel fitting.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a block diagram showing an apparel fitting system according to an embodiment of the invention;

FIG. 2 is an exemplary screenshot of an apparel fitting system according to an embodiment of the invention;

FIG. 3 is an exemplary screenshot of an apparel fitting system making a selection according to an embodiment of the invention;

FIG. 4 is another exemplary screenshot of an apparel fitting system making another selection according to an embodiment of the invention;

FIG. 5 is an exemplary screenshot of an apparel fitting system displaying with suggestion including proper sizes according to an embodiment of the invention;

FIG. 6 is a flow chart showing steps for an apparel fitting system according to an embodiment of the invention.

### DETAILED DESCRIPTION EMBODIMENTS OF THE INVENTION

Referring to the figures, the embodiments of the invention are described in detail.

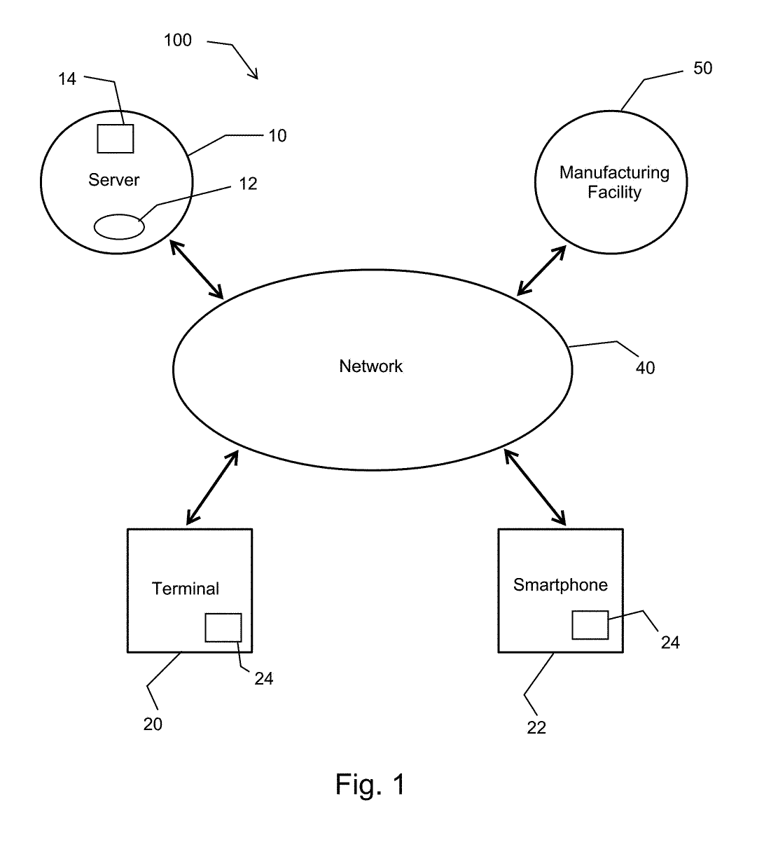

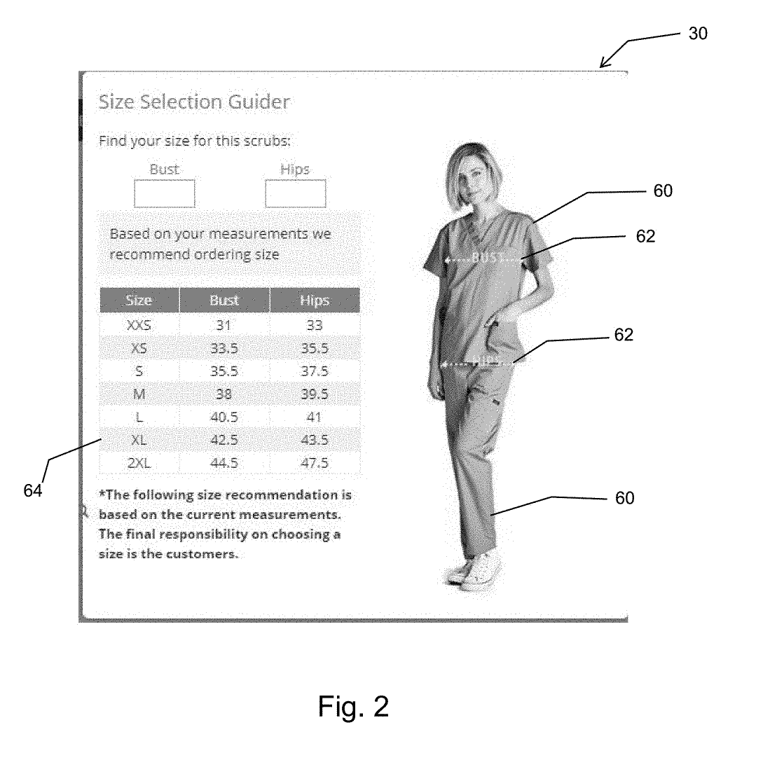

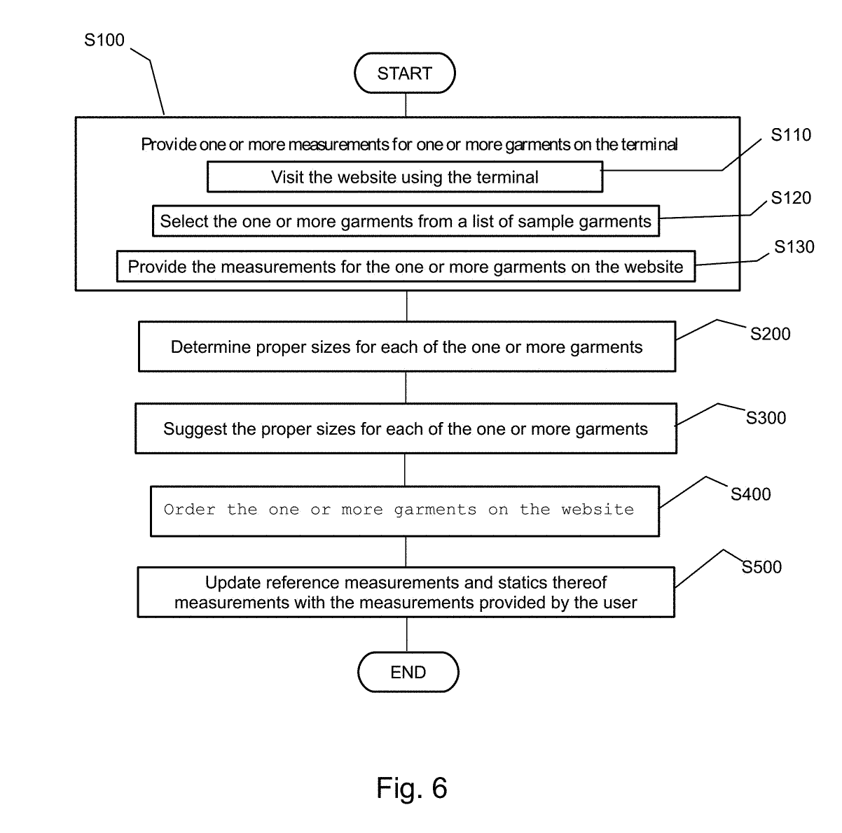

FIG. 1 shows a block diagram of an apparel fitting system, FIGS. 2-5 show exemplary screenshots of an apparel fitting system, and FIG. 6 shows a flow chart for steps for an apparel fitting system according to an embodiment of the invention.

A method is provided for apparel fitting in an apparel fitting system (100) including a server (10), a terminal (20) configured to be accessed by a user, and a website (30), in which the server (10) and the terminal (20) are connected to each other over a network (40) as shown in FIG. 1. In the illustrated embodiment, the elements (10, 20, 22, 40) can communicate or exchange information with one another through the network (40). The network (40) may be an Internet, an intranet, or even a local network. In certain embodiments of the invention, the elements (10, 20, 22, 40) can communicate or exchange information with one another directly without the network (40).

As shown in FIGS. 2 through 6, the method for apparel fitting system (100) comprises steps for: providing one or more measurements (62) for one or more garments (60) on the terminal (20) by the user (S100); determining proper sizes for each of the one or more garments (60) by the server (10) using the one or more measurements (62) received from the terminal (20) and a plurality of garment tables (12) stored in the server (10) (S200); and suggesting the proper sizes for each of the one or more garments (60) to the user through the terminal (20) by the server (300). In the illustrated embodiment of the invention, the user or customer can access the server (10) through his own terminal (20) or smartphone (22), in order to determine the right sizes for garments (60) on line.

The step for providing (S100) may comprise steps for: visiting the website (30) using the terminal (S110), and the website (30) is managed by the server (10) on the network (40); selecting the one or more garments (60) from a list of sample garments (68) that the website (30) provides along with information (64) on the sample garments; and providing the one or more measurements (62) for the one or more garments (60) on the website (30) by inputting or choosing from values provided by the website (30). The list of sample garments, which can be the element (60), may be displayed graphically on the website (30) as shown in FIGS. 2-5.

The information (64) on the sample garments (60) may be provided in terms of text, graphics, pictures, video, and even audio.

The plurality of garment tables (12) may be provided in a form of database stored in the server (10) and managed by the website (30).

The plurality of garment tables (12) may comprise reference measurements (as in the information (64) in FIG. 2) of the sample garments (60) and statistics of reference measurements (30).

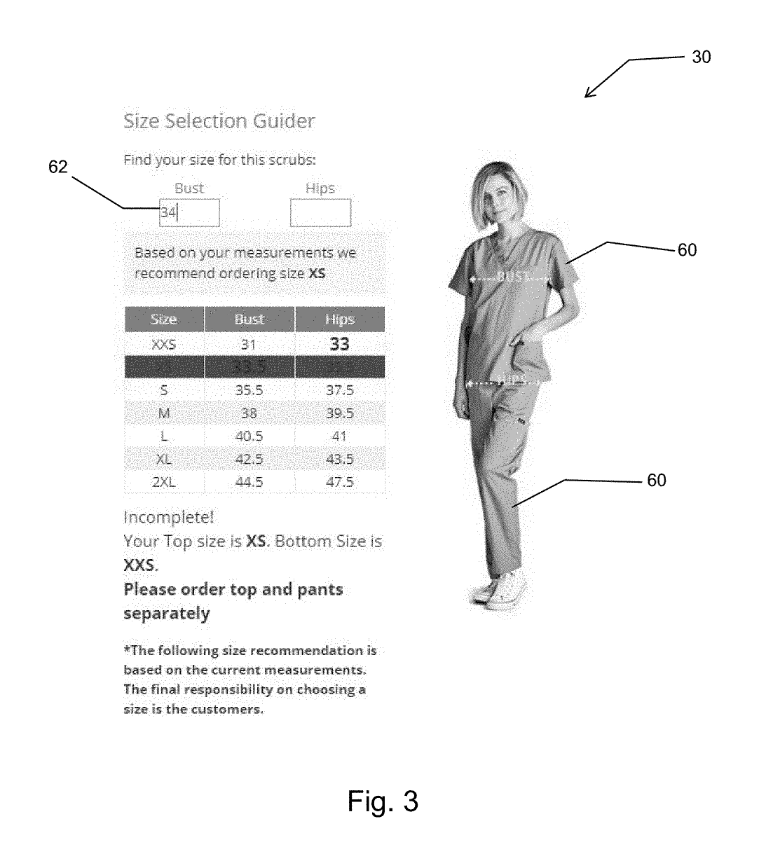

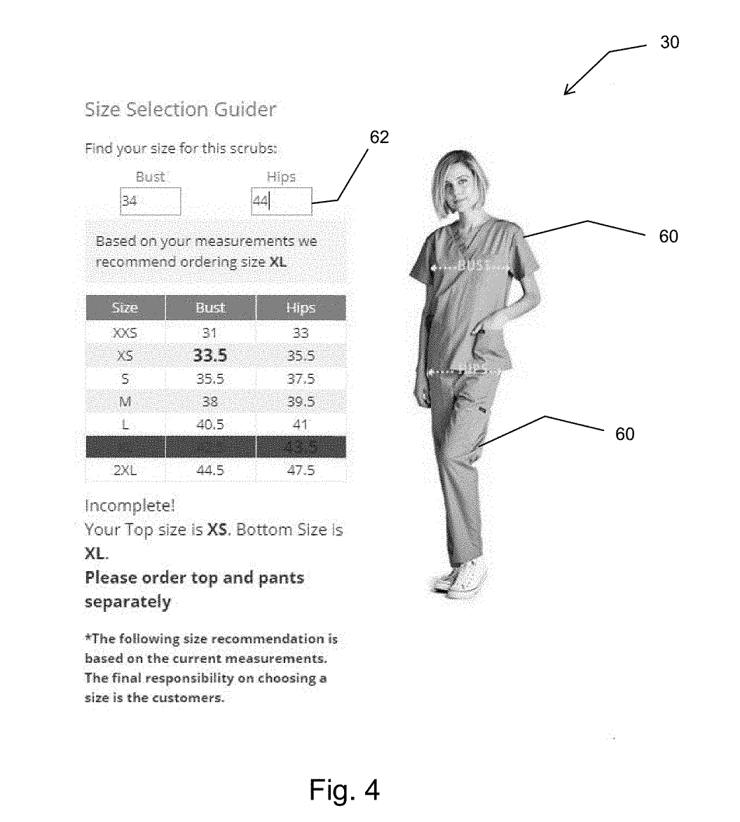

The one or more measurements (62) may comprise a bust measurement and a hip measurement as shown in FIGS. 3 through 4.

The one or more measurements (62) may further comprise a waist measurement, a thigh measurement, an inseam measurement, a sleeve length measurement, a neck measurement, a bicep measurement, and a combination thereof. By including such additional measurements as in the above, the accuracy of proper sizes for the apparel fitting system (100), the server (10, and/or the website (30) to recommend may be increased a lot.

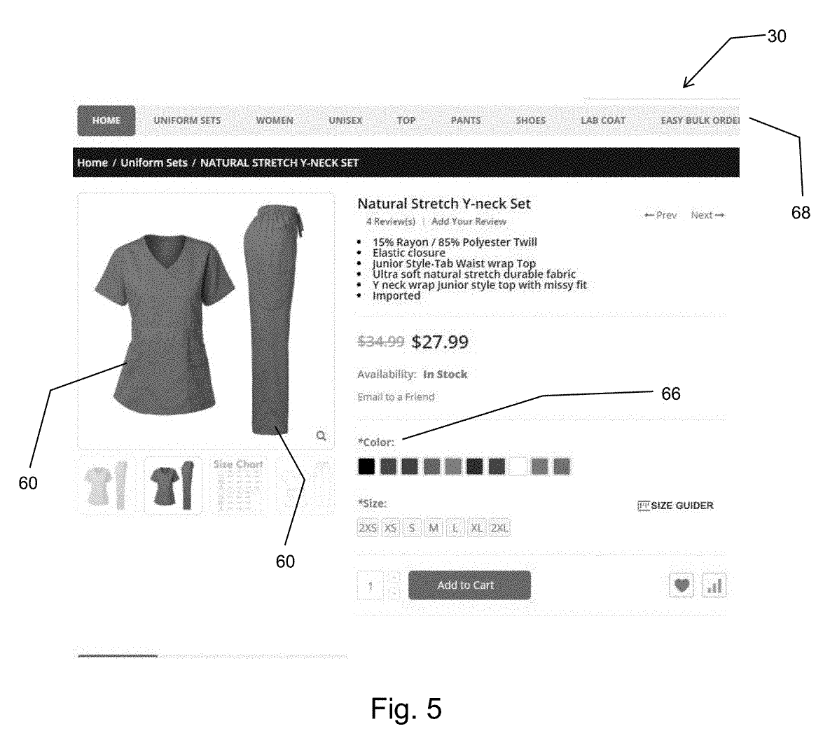

The method may further comprise a step (S400) for ordering the one or more garments (60) on the website (30) by the user and such orders may be delivered directly to a manufacturing facility (50) as shown in FIGS. 1 and 5. The user may place an order for the garments (60) through a website (30) as shown in FIG. 5.

The website (30) may be provided accessibly on the network (40), and each of the server (10) and the terminal (20) includes one or more memory device (14, 24) configured to store programs, data, and calculation results from each of the steps as shown in FIG. 1.

The method may further comprise a step (S500) for updating reference measurements (64) and statics of the reference measurements (64) with the one of more measurements (62) provided by the user. By updating the reference measurements (64), the server (10) or the website (30) can increase the accuracy of recommending of proper sizes for the garments (60).

Each of the server (10) and the terminal (20) may comprise at least one information processing unit (not shown) and at least one display, on which the website (30) may be displayed.

The step (S300) for suggesting proper sizes may further comprise a step for selecting additional features of the one or more garments including colors (66) as shown in FIG. 6.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A method for apparel fitting in an apparel fitting system including a server, a terminal accessed by a user, and a website, wherein the server and the terminal are connected to each other over a network, the method comprising steps for:
providing one or more measurements for one or more garments on the terminal by the user;
determining proper sizes for each of the one or more garments by the server using the one or more measurements received from the terminal and a plurality of garment tables stored in the server; and
suggesting the proper sizes for each of the one or more garments to the user through the terminal by the server.

2. The method of claim 1, wherein the step for providing comprises steps for:
visiting the website using the terminal, wherein the website is managed by the server on the network;
selecting the one or more garments from a list of sample garments that the website provides along with information on the sample garments; and
providing the one or more measurements for the one or more garments on the website by inputting or choosing from values provided by the website.

3. The method of claim 2, wherein the list of sample garments is displayed graphically on the website.

4. The method of claim 3, wherein the information on the sample garments are provided in terms of text, graphics, pictures, video, and audio.

5. The method of claim 1, wherein the plurality of garment tables are provided in a form of database stored in the server and managed by the website.

6. The method of claim 5, wherein the plurality of garment tables comprise reference measurements of the sample garments and statistics of reference measurements.

7. The method of claim 1, wherein the one or more measurements comprise a bust measurement and a hip measurement.

8. The method of claim 7, wherein the one or more measurements further comprise a waist measurement, a thigh measurement, an inseam measurement, a sleeve length measurement, a neck measurement, a bicep measurement, and a combination thereof.

9. The method of claim 1, further comprising a step for ordering the one or more garments on the website by the user.

10. The method of claim 9, wherein the website is provided accessibly on the network, and wherein each of the server and the terminal includes one or more memory device configured to store programs, data, and calculation results from each of the steps.

11. The method of claim 1, further comprising a step for updating reference measurements and statics of the reference measurements with the one of more measurements provided by the user.

12. The method of claim 1, wherein each of the server and the terminal comprises at least one information processing unit and at least one display.

13. The method of claim 1, wherein the step for suggesting proper sizes further comprises a step for selecting additional features of the one or more garments including colors.
